(19) United States
(12) Patent Application Publication
(10) Pub. No.: US 2026/0311188 A1
(43) Pub. Date: Oct. 8, 2026

(54) PAGE LOADING METHOD, COMPUTER SYSTEM, AND COMPUTER-READABLE STORAGE MEDIUM

(71) Applicant: Advanced Nova Technologies (Singapore) Holding Pte. Ltd., Singapore (SG)

(72) Inventors: Zhiqiang ZHOU, Hangzhou (CN); Wenyang WANG, Hangzhou (CN); Mian ZHANG, Hangzhou (CN)

(21) Appl. No.: 19/416,958

(22) Filed: Dec. 11, 2025

(30) Foreign Application Priority Data
Apr. 8, 2025 (SG) 10202500924Y

(51) Int. Cl. G06Q 20/42; G06Q 20/30

(52) U.S. Cl. CPC G06Q 20/42; G06Q 20/30

(57) ABSTRACT

Embodiments of this specification disclose a page loading method, a computer system, and a computer-readable storage medium. A template loading page of a target channel may be pre-generated. When a user fills in a payment element, a payment page of the target channel is preloaded by using the template loading page.

### TECHNICAL FIELD

This specification relates to the field of computer technologies, and in particular, to a page loading method, a computer system, and a computer-readable storage medium.

### BACKGROUND

In a common online payment process, after a user confirms a to-be-paid order by using a merchant application, the user needs to jump to a payment channel, and perform a series of operations such as identity authentication on a payment page of the payment channel to complete payment of the order. Currently, interface stability of each payment channel varies greatly, and it takes a relatively long time to jump to some payment channels, which may affect payment experience and payment intention of the user.

Therefore, this specification provides a page loading method, a computer system, and a computer-readable storage medium.

### SUMMARY

Embodiments of this specification provide a page loading method and apparatus, a storage medium, and a computer system, so as to partially resolve the foregoing problems in the conventional technology.

This specification provides a page loading method, including: after a user determines a target channel used for payment, creating a payment order and loading a template loading page corresponding to the target channel; sending the payment order to a service provider that provides the target channel; determining a non-cacheable resource of a payment page of the service provider based on an interface address returned by the service provider; and generating the payment page of the target channel based on the non-cacheable resource and the template loading page.

This specification provides a page loading system, where the system includes a page cache system and a merchant application. The page cache system is configured to: for any payment channel, generate a template loading page corresponding to the payment channel by using a cacheable resource on a payment page of the payment channel. The merchant application is configured to: after a user determines a target channel used for payment, create a payment order and load a template loading page corresponding to the target channel; send the payment order to a service provider that provides the target channel; determine a non-cacheable resource of a payment page of the service provider based on an interface address returned by the service provider; and generate the payment page of the target channel based on the non-cacheable resource and the template loading page.

This specification provides a computer system, including a memory, a processor, and a computer program that is stored in the memory and that is capable of running on the processor, where the processor executes the program to implement the foregoing page loading method.

This specification provides a computer-readable nonvolatile storage medium, where the storage medium stores a computer program, and the computer program is executed by a processor to implement the foregoing page loading method.

According to at least one of the foregoing technical solutions used in the embodiments of this specification, at least one of the following beneficial effects can be achieved: A template loading page of a target channel may be pre-generated. When a user fills in a payment element, a payment page of the target channel is preloaded by using the template loading page, thereby accelerating opening of the payment page and improving payment experience of the user.

### BRIEF DESCRIPTION OF DRAWINGS

The accompanying drawings described herein are used to provide a further understanding of this specification and constitute a part of this specification. The example embodiments of this specification and descriptions thereof are used to explain this specification, and do not constitute an improper limitation on this specification. In the accompanying drawings:

FIG. 1 is a schematic flowchart of a page loading method in this specification;

FIG. 2 is a schematic diagram of an order placing interface of a merchant application in this specification;

FIG. 3 is a schematic diagram of a payment page of a payment channel in this specification;

FIG. 4 is a schematic diagram of a payment element filling interface of a merchant application in this specification;

FIG. 5 is a schematic flowchart of pre-generating a template loading page in this specification;

FIG. 6 is a schematic structural diagram of a page loading system in this specification; and

FIG. 7 is a schematic structural diagram of a computer system according to an embodiment of this specification.

### DESCRIPTION OF EMBODIMENTS

To make the objectives, technical solutions, and advantages of this specification clearer, the following clearly and comprehensively describes the technical solutions of this specification with reference to specific embodiments and corresponding accompanying drawings of this specification. Clearly, the described embodiments are merely some but not all of embodiments of this specification. All other embodiments obtained by a person of ordinary skill in the art based on the embodiments of this specification without creative efforts shall fall within the protection scope of this specification.

The following describes in detail the technical solutions provided in the embodiments of this specification with reference to the accompanying drawings.

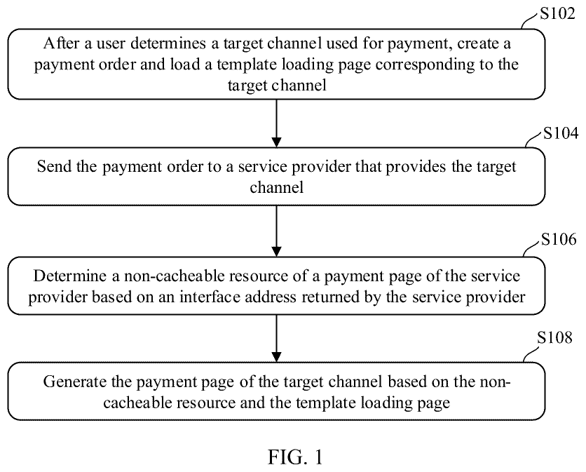

FIG. 1 is a schematic flowchart of a page loading method in this specification.

Before the method in FIG. 1 is performed, the following step may be further performed: for any payment channel, pre-generating a template loading page corresponding to the payment channel by using a cacheable resource on a payment page of the payment channel.

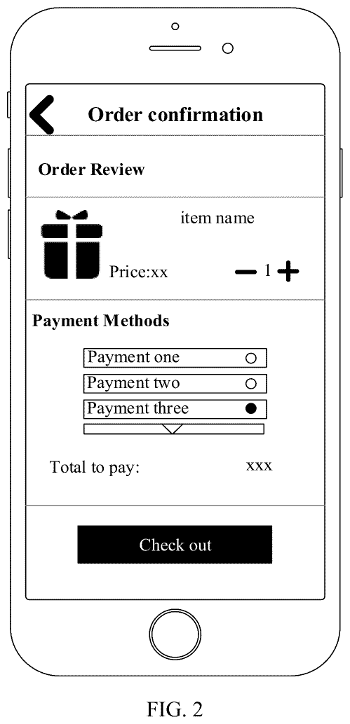

For example, in an e-commerce scenario, users often come from different regions, and commonly used payment channels are also different. Therefore, a merchant or an acquiring institution that cooperates with the merchant needs to connect to several different payment channels to support payment behavior of a user. In a common order placing and payment procedure, after a user selects a product in a merchant application, the merchant application jumps to an order placing interface shown in FIG. 2. The user determines transaction content in the order placing interface and selects a payment channel, and then places an order to the merchant application by using a confirmation key on the page. The merchant application creates a payment order based on the content submitted by the user and jumps to a subsequent payment element filling page. The user fills in a payment element in the payment element filling page, and confirms and submits the payment element. The merchant application improves the payment order based on the payment element filled in by the user, then sends the payment order to a service provider of the payment channel selected by the user, and jumps to the payment page of the payment channel based on an interface address returned by the service provider of the payment channel.

In this order placing and payment procedure, it takes a relatively long time for the merchant application to load the payment page of the payment channel in real time, which may affect payment experience of the user. Therefore, this specification provides a page loading method. The method may be applied to a merchant application. For any payment channel supported by the merchant application, before a user places an order by using the merchant application, a template loading page corresponding to the payment channel is pre-generated by using a cacheable resource on a payment page of the payment channel. Specific steps of the solution may be implemented by the merchant application itself, or may be implemented by a tool of an acquiring institution that is integrated into the merchant application, or the like, which is not distinguished in this specification, and is collectively described as being implemented by the merchant application for brevity of expression.

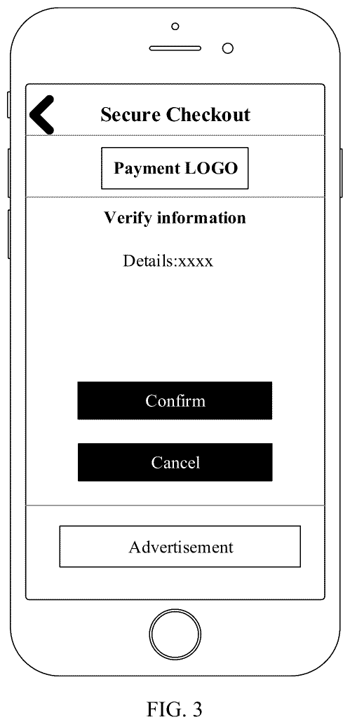

Specifically, as shown in FIG. 3, the payment page of the payment channel may include an identifier of the payment channel, order information of a payment order corresponding to the payment page, and elements such as an advertisement. Elements on a payment page of each payment channel are not limited to the foregoing types, and payment pages of some payment channels may further include input fields for a user account and a password.

For a payment page of any payment channel, after a payment order is sent to a service provider of the payment channel to request the payment page, an interface address returned by the service provider of the payment channel based on the payment order may be obtained. A request is sent to the interface address to obtain html code of the payment page returned in a form of an html response. The html code is parsed to determine whether each element on the payment page of the payment channel is a cacheable resource. Content of each cacheable resource is recorded, and a cacheable resource list corresponding to the payment channel is generated. Then, a template loading page corresponding to the payment channel is generated based on the cacheable resource list corresponding to the payment channel.

The cacheable resource is an element that supports caching and that has a relatively long update period on the payment page. For example, for an identifier of an element, namely, a payment channel on the foregoing payment page, the element may be used as a cacheable resource because the identifier of the payment channel has a relatively long update period and generally supports caching.

The template loading page may be an html file, and the template loading page includes a label and content of each cacheable resource. The content of the cacheable resource may be a uniform resource locator (Uniform Resource Locator, URL), so that when the template loading page is loaded, loading of the cacheable resource may be completed by using the uniform resource locator.

Therefore, through analysis of a payment page of each payment channel in advance, before the user places an order, preparation has been made for preloading the payment page, thereby shortening a time required for preloading when the user fills in a payment element in subsequent step S102.

In one or more embodiments of this specification, template generation frequency may be preset, and a template loading page corresponding to each payment channel is updated by using the foregoing method for generating a template loading page based on the template generation frequency in each template generation period and by using a payment page, obtained in a time segment represented by the template generation period, of each payment channel.

In one or more embodiments of this specification, the template loading page corresponding to the payment channel may be generated based on a pre-stored interface address of the payment channel or pre-stored html code of the payment page of the payment channel.

In one or more embodiments of this specification, for one payment channel, specific content of the template loading page is as follows:

```
  <!DOCTYPE html>
  <html>
  <head>
  <link href=‘https://some-payment-channel.com/can-be-cached-resource1.css’>
  <link href=‘https://some-payment-channel.com/can-be-cached-resource2.css’>
  <link href=‘https://some-payment-channel.com/can-be-cached-resource3.css’>
  <script src=‘https://some-payment-channel.com/can-be-cached-
resource4.js’></script>
  <script src=‘https://some-payment-channel.com/can-be-cached-
resource5.js’></script>
  <script src=‘https://some-payment-channel.com/can-be-cached-
resource6.js’></script>
  </head>
  </html>
```

S102: After a user determines a target channel used for payment, create a payment order and load a template loading page corresponding to the target channel.

It should be noted that a process of generating the template loading page and subsequent steps S102 to S108 are mutually decoupled processes. To be specific, in the method provided in this specification, step S102 is performed in a process in which the user uses the merchant application to place an order. The method provided in this specification only needs to ensure that the process of generating the template loading page when the user uses the merchant application to place an order is completed, and does not need to ensure that the process of generating the template loading page and step S102 are consecutive in terms of time.

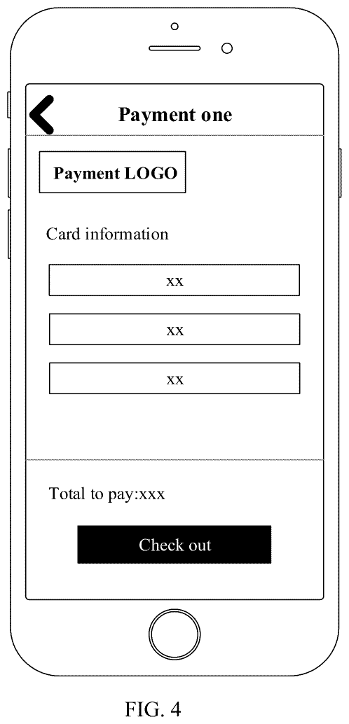

Specifically, in the foregoing process in which the user uses the merchant application to place an order, after the user determines a target channel for payment by the user, the user also determines order information such as an ordered product and a payment amount. Therefore, the merchant application may determine the payment channel selected by the user as the target channel, create a payment order based on the order information, determine, according to a rule of the target channel, a payment element that needs to be filled in by the user, and display a payment element filling page to the user in a front-end interface of the merchant application. FIG. 4 shows the payment element filling page of the merchant application. In the payment element filling interface, the user may fill in account information of the user in the payment channel. When creating the payment order, the merchant application may further load, in the background, a pre-generated template loading page corresponding to the target channel. It can be learned from the foregoing description that the template loading page corresponds to the payment page of the target channel, and each cacheable resource on the template loading page may be used to form the payment page of the target channel.

Therefore, preloading of the payment page of the target channel is completed by using the time during which the user fills in the payment element. When the payment page needs to be generated in a subsequent step, each cacheable resource that has been loaded in step S102 does not need to be repeatedly loaded into the template loading page. This accelerates a process in which the user jumps from the merchant application to the payment channel, thereby improving payment experience of the user.
S104: Send the payment order to a service provider that provides the target channel.

After the user completes the filling of the payment element on the payment element filling page, in response to a confirmation operation performed by the user in the merchant application, the payment order confirmed by the user is sent, by using an interface corresponding to the target channel, to the service provider that provides the target channel.
S106: Determine a non-cacheable resource of a payment page of the service provider based on an interface address returned by the service provider.

After receiving the payment order sent by the merchant application, the service provider that provides the target channel sends an interface address of a payment page corresponding to the payment order to the merchant application.

After receiving the interface address returned by the service provider, the merchant application may determine a payment page of the service provider as a real-time page based on the interface address, and determine, based on a pre-stored cacheable resource list, an element that does not belong to the cacheable resource list on the real-time page as a non-cacheable resource.

Specifically, in an actual application scenario, the non-cacheable resource may include a dynamic advertisement or another dynamic component with relatively strong timeliness in the payment channel.
S108: Generate the payment page of the target channel based on the non-cacheable resource and the template loading page.

After the non-cacheable resource on the real-time page is determined, the payment page of the target channel may be generated based on the preloaded template loading page and the determined non-cacheable resource, and may be displayed to the user in the front-end interface of the merchant application.

Specifically, a different resource between the real-time page and the loaded template loading page of the target channel may be determined, and the different resource continues to be loaded into the loaded template loading page by using a framework of the real-time page, so as to generate a payment page that is finally displayed to the user.

The foregoing different resource may include the non-cacheable resource determined in step S106 and the cacheable resource that is not completely loaded into the template loading page.

In a page loading method shown in FIG. 1, a template loading page of a target channel may be pre-generated. When a user fills in a payment element, a payment page of the target channel is preloaded by using the template loading page, thereby accelerating opening of the payment page and improving payment experience of the user.

In a process of pre-generating the template loading page, the cacheable resource on the payment page of the payment channel is determined based on response header information on the payment page of the payment channel, where the response header information includes a cache mark corresponding to each element on the payment page.

According to the foregoing description, after a request is sent to the service provider of the payment channel to request the payment page, html code of the payment page that is returned by the service provider of the payment channel in a form of an html response may be obtained. The html code may include a response state and a resource requested by the request. The response state may be represented in a form of response header information, and content of the response header information is determined, so as to obtain a determining result indicating whether each element on the payment page of the payment channel has a cacheable mark. Further, for any element, whether the element is a cacheable resource is determined based on the determining result corresponding to the element.

A manner of sending the request to the service provider of the payment channel may be sending an obtaining request to each element having a uniform resource locator on the payment page to obtain response header information corresponding to the element, so as to further determine whether the element is a cacheable result. A method for determining, based on a determining result, whether the element is a cacheable resource may be directly determining the element with a cacheable mark as a cacheable resource, or determining, based on an element name of the element, that the element name meets a preset caching rule, and the element with a cacheable mark is a cacheable resource. Specifically, the caching rule may be presetting several element names. When the element name of the element meets any preset element name, the element meets the caching rule. For example, the caching rule may be preset to “img”. When an element name of an element A is “img” and a determining result corresponding to the element A is that the element A has a cacheable mark, the element A is a cacheable resource.

Further, the response header information specifically includes cache control header information. In a process of pre-generating a template loading page, for any element on the payment page of the payment channel, whether the element has a cacheable mark is determined based on cache control header information corresponding to the element; and whether the element is a cacheable resource is determined based on the determining result.

A response header attribute may include a cache control header (Cache-Control). Correspondingly, response header information of the cache control header is cache control header information, and the cache control header information may be “public”, “no-store”, or the like. Therefore, it may be determined whether each piece of cache control header information is a cacheable mark, and further, a control result indicating whether the element has a cacheable mark is obtained. For example, when cache control header information of an element B is “public”, a determining result corresponding to the element B is that the element B has a cacheable mark. In an actual application process, whether each cache control header information is a cacheable mark may be preset according to a requirement. For example, based on a server characteristic of the merchant application, the cache control header information “private” may be set to a cacheable mark or may be set to a non-cacheable mark.

In addition, the response header information may further include expiration time information. In a process of generating a template loading page, after a determining result corresponding to the element is determined, an update period of the element is determined based on the expiration time information corresponding to the element, and whether the element is a cacheable resource is determined based on the determining result and the update period.

The response header attribute may further include an expiration time (expires). Correspondingly, response header information of the expiration time is the expiration time information. The expiration time information may indicate an available time of an element. To be specific, before an expiration time of an element C arrives, content of the element C returned in the current response is available content; however, after the expiration time of the element C arrives, the content of the element C needs to be obtained again. Therefore, the update period of the element may be determined based on a moment at which the merchant application obtains a response returned by the payment channel and the expiration time of each element in the response. The update period may be represented in a form of time required for each update of the element.

Specifically, in an actual business scenario, according to the method provided in this specification, preloading of the payment page is performed by using the time during which the user fills in the payment element. However, it usually does not take too much time for the user to fill in the payment element. This also means that for any cacheable resource, it is only required that the expiration time of the cacheable resource be later than a moment at which the user completes the filling of the payment element and makes a confirmation. The cacheable resource does not need to be updated after being successfully loaded into the template loading page, and may be applied to a subsequent step to generate a payment page. Therefore, a period threshold may be preset. When any element has a cacheable mark, and a period frequency corresponding to the element is not less than the period threshold, the element may be determined as a cacheable resource.

In addition, before the process of pre-generating the template loading page, for any payment channel, a virtual payment order is sent to a service provider that provides the payment channel; an interface address returned, based on the virtual payment order, by the service provider of the payment channel is obtained; and a payment page of the payment channel is determined based on the obtained interface address.

In the method provided in this specification, to generate a template loading page corresponding to each payment channel, the foregoing manner may be used. To be specific, when the user makes payment by using any payment channel, the merchant application sends a request to a service provider of the payment channel to obtain a payment page of the payment channel, or a payment page corresponding to each payment channel may be determined by using an interface address predetermined by interconnecting with each payment channel. However, when one merchant application needs to interconnect with a large quantity of payment channels (usually hundreds of payment channels in an actual application scenario), some payment channels may be used only by a small quantity of users, and it is impossible to obtain payment pages of all payment channels in a timely manner in the foregoing template generation period. In addition, a process of interconnecting with a large quantity of channel providers in advance to obtain interface addresses is cumbersome. To resolve the foregoing problems, the merchant application may send, based on preset template generation frequency, a virtual payment order to each service provider that provides a payment channel, and obtain an interface address returned, based on the virtual payment order, by the service provider of each payment channel. Therefore, an interface address of each payment channel may be obtained in a stable and timely manner based on the template generation frequency, and the payment page of each payment channel is further obtained.

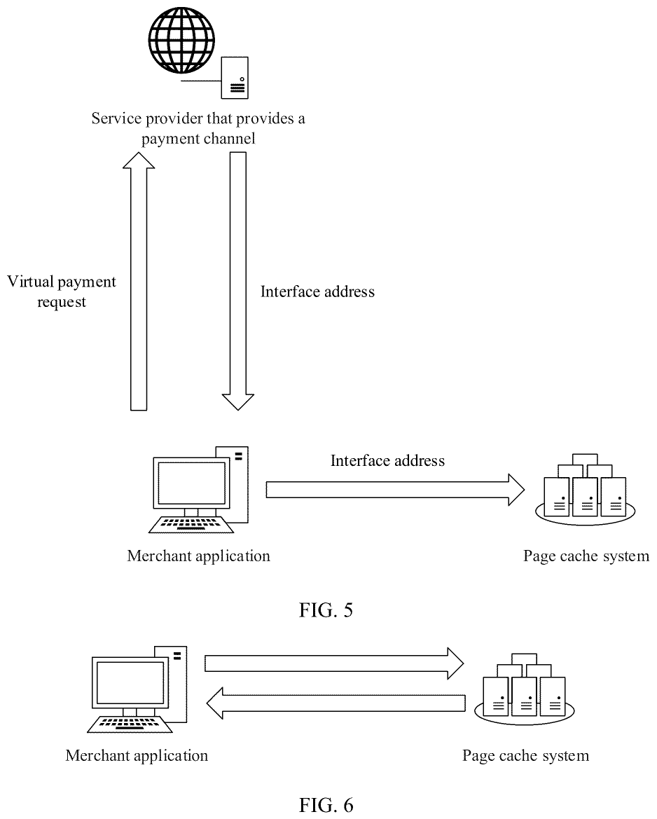

In one or more embodiments of this specification, an execution entity of this specification is a page loading system. The page loading system includes a page cache system and a merchant application. A process of pre-generating a template loading page is shown in FIG. 5. The merchant application is configured to: before a template loading page corresponding to a payment channel is generated, send a virtual payment order to a service provider that provides the payment channel; obtain an interface address returned, based on the virtual payment order, by the service provider of the payment channel; and then send the interface address to the page cache system. The page cache system is configured to: determine a payment page of the payment channel based on the interface address, obtained by the merchant application, corresponding to the payment channel; and generate the template loading page corresponding to the payment channel based on a cacheable resource on the payment page of the payment channel.

The page cache system and the merchant application may be arranged in different servers or terminals. After obtaining the interface address returned, based on the payment order, by each payment channel, the merchant application may send the obtained interface address to the page cache system, so that the page cache system generates a template loading page corresponding to each payment channel by using the received interface address. In this way, the process of generating a template loading page does not need to be performed by the merchant application, thereby reducing execution load of the merchant application.

In addition, the cacheable resource specifically includes a logical statement. In the process of generating a template loading page, the template loading page of the payment channel is generated in a manner in which the logical statement is only loaded and not executed.

In html code, a type of an element may include a JavaScript logical statement. When step S102 of loading the template loading page corresponding to the target channel by the merchant application is performed, if the cacheable resource on the template loading page is the JavaScript logical statement, the JavaScript logical statement is directly executed in a common loading manner. However, because step S102 is a preloading process, in this preloading process, each non-cacheable resource on the payment page corresponding to the target channel is not loaded into the template loading page. In addition, because the JavaScript logical statement usually involves real-time logic determining and execution, the JavaScript logical statement directly loaded and executed in the preloading process in step S102 is usually applied to subsequent step S108 to generate a payment page, which causes a waste of the CPU and traffic of the terminal in which the merchant application is deployed. In an international acquiring scenario, a problem exists in connection stability and transmission efficiency of payment pages of payment channels. Consequently, in the preloading process, loading and executing the JavaScript logical statement may cause a problem that it is impossible to completely load all cacheable resources within a limited time during which the user fills in a payment element.

Therefore, the template loading page of the payment channel is generated in a manner in which the logical statement is only loaded and not executed. Specifically, an attribute of the logical statement may be set to “preload” during generation of the template loading page.

In addition, in the process of generating the template loading page, for any payment channel, a resource identifier of a cacheable resource on a payment page of the payment channel is determined based on an interface address corresponding to the payment channel, and a template loading page corresponding to the payment channel is generated based on a resource address corresponding to each cacheable resource.

The page loading method provided in the embodiments of this specification is described above. Based on the same idea, this specification further provides a corresponding page loading system. As shown in FIG. 6, the page loading system includes a page cache system and a merchant application. The page cache system is configured to: for any payment channel, generate a template loading page corresponding to the payment channel by using a cacheable resource on a payment page of the payment channel. The merchant application is configured to: after a user determines a target channel used for payment, create a payment order and load a template loading page corresponding to the target channel; send the payment order to a service provider that provides the target channel; determine a non-cacheable resource of a payment page of the service provider based on an interface address returned by the service provider; and generate the payment page of the target channel based on the non-cacheable resource and the template loading page.

In one or more embodiments of this specification, the merchant application is further configured to: before the template loading page corresponding to the payment channel is generated, send a virtual payment order to a service provider that provides the payment channel, and obtain an interface address returned, based on the virtual payment order, by the service provider of the payment channel; and the page cache system is specifically configured to determine a payment page of the payment channel based on the interface address, obtained by the merchant application, corresponding to the payment channel.

In one or more embodiments of this specification, the page cache system is specifically configured to: for any payment channel, determine a resource identifier of a cacheable resource on a payment page of the payment channel based on an interface address corresponding to the payment channel, and generate a template loading page corresponding to the payment channel based on a resource address corresponding to each cacheable resource.

The specification also provides a computer-readable non-transitory storage medium, wherein the storage medium stores a computer program, which, when executed by a processor, can be used to perform one or more steps of one or more methods described or illustrated herein or provides functionality described or illustrated herein. Herein, the computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

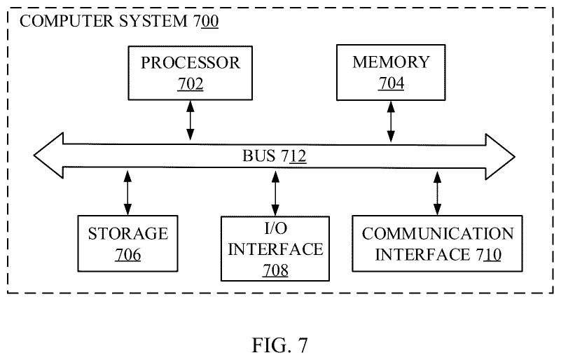

The specification also provides a computer system. FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLB s). Instructions in the instruction caches may be copies of instructions in memory 704 or storage 706, and the instruction caches may speed up retrieval of those instructions by processor 702. Data in the data caches may be copies of data of 70 in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

It should be further noted that, the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

The embodiments of this specification are described in a progressive way. For same or similar parts in the embodiments, references can be made to each other. Each embodiment focuses on a difference from another embodiment. Particularly, some system embodiments are briefly described because they are basically similar to some method embodiments. For related parts, references can be made to related descriptions in some method embodiments.

The above-mentioned descriptions are merely embodiments of this specification, and are not intended to limit this specification. A person skilled in the art can make various modifications and changes to this specification. Any modification, equivalent replacement, improvement, etc. made without departing from the spirit and principle of this specification shall fall within the scope of the claims in this application.

1. A page loading method, comprising:
after a user determines a target channel used for payment, creating a payment order and loading a template loading page corresponding to the target channel;
sending the payment order to a service provider that provides the target channel;
determining a non-cacheable resource of a payment page of the service provider based on an interface address returned by the service provider; and
generating the payment page of the target channel based on the non-cacheable resource and the template loading page.

2. The method according to claim 1, further comprising:
for any payment channel, generating a template loading page corresponding to the payment channel by using a cacheable resource on a payment page of the payment channel.

3. The method according to claim 2, wherein the generating a template loading page corresponding to the payment channel by using a cacheable resource on a payment page of the payment channel comprises:
determining the cacheable resource on the payment page of the payment channel based on response header information on the payment page of the payment channel, wherein the response header information comprises a cache mark corresponding to each element on the payment page.

4. The method according to claim 3, wherein the response header information comprises cache control header information; and
the determining the cacheable resource on the payment page of the payment channel based on response header information on the payment page of the payment channel comprises:
for any element on the payment page of the payment channel, determining, based on cache control header information corresponding to the element, whether the element has a cacheable mark; and
determining, based on a determining result, whether the element is a cacheable resource.

5. The method according to claim 4, wherein the cache control header information comprises expiration time information; and
the determining, based on a determining result, whether the element is a cacheable resource comprises:
determining an update period of the element based on the expiration time information corresponding to the element; and
determining, based on the determining result and the update period, whether the element is a cacheable resource.

6. The method according to claim 2, before the generating a template loading page corresponding to the payment channel by using a cacheable resource on a payment page of the payment channel, further comprising:
for any payment channel, sending a virtual payment order to a service provider that provides the payment channel, and obtaining an interface address returned, based on the virtual payment order, by the service provider of the payment channel; and
determining a payment page of the payment channel based on the obtained interface address.

7. The method according to claim 2, wherein the cacheable resource comprises a logical statement; and
the generating a template loading page corresponding to the payment channel by using a cacheable resource on a payment page of the payment channel comprises:
generating the template loading page of the payment channel in a manner in which the logical statement is only loaded and not executed.

8. A computer system, comprising a memory, a processor, and a computer program that is stored in the memory and that is capable of running on the processor, wherein the processor executes the program to implement the following steps:
after a user determines a target channel used for payment, creating a payment order and loading a template loading page corresponding to the target channel;
sending the payment order to a service provider that provides the target channel;
determining a non-cacheable resource of a payment page of the service provider based on an interface address returned by the service provider; and
generating the payment page of the target channel based on the non-cacheable resource and the template loading page.

9. The computer system according to claim 8, wherein the processor executes the program to further implement the following steps:
for any payment channel, generating a template loading page corresponding to the payment channel by using a cacheable resource on a payment page of the payment channel.

10. The computer system according to claim 9, wherein the generating a template loading page corresponding to the payment channel by using a cacheable resource on a payment page of the payment channel comprises:
determining the cacheable resource on the payment page of the payment channel based on response header information on the payment page of the payment channel, wherein the response header information comprises a cache mark corresponding to each element on the payment page.

11. The computer system according to claim 10, wherein the response header information comprises cache control header information; and
the determining the cacheable resource on the payment page of the payment channel based on response header information on the payment page of the payment channel comprises:
for any element on the payment page of the payment channel, determining, based on cache control header information corresponding to the element, whether the element has a cacheable mark; and
determining, based on a determining result, whether the element is a cacheable resource.

12. The computer system according to claim 11, wherein the cache control header information comprises expiration time information; and
the determining, based on a determining result, whether the element is a cacheable resource comprises:
determining an update period of the element based on the expiration time information corresponding to the element; and
determining, based on the determining result and the update period, whether the element is a cacheable resource.

13. The computer system according to claim 9, wherein before the generating a template loading page corresponding to the payment channel by using a cacheable resource on a payment page of the payment channel, the processor executes the program to further implement the following steps:
for any payment channel, sending a virtual payment order to a service provider that provides the payment channel, and obtaining an interface address returned, based on the virtual payment order, by the service provider of the payment channel; and
determining a payment page of the payment channel based on the obtained interface address.

14. The computer system according to claim 9, wherein the cacheable resource comprises a logical statement; and
the generating a template loading page corresponding to the payment channel by using a cacheable resource on a payment page of the payment channel comprises:
generating the template loading page of the payment channel in a manner in which the logical statement is only loaded and not executed.

15-16. (canceled)

17. A non-transitory computer-readable nonvolatile storage medium, wherein the non-transitory computer-readable nonvolatile storage medium stores a computer program, which when executed by a processor, causes the processor to:
after a user determines a target channel used for payment, create a payment order and load a template loading page corresponding to the target channel;
send the payment order to a service provider that provides the target channel;
determine a non-cacheable resource of a payment page of the service provider based on an interface address returned by the service provider; and
generate the payment page of the target channel based on the non-cacheable resource and the template loading page.

18. The non-transitory computer-readable nonvolatile storage medium according to claim 17, wherein the computer program when executed by the processor further causes the processor to:
for any payment channel, generate a template loading page corresponding to the payment channel by using a cacheable resource on a payment page of the payment channel.

19. The non-transitory computer-readable nonvolatile storage medium according to claim 18, wherein the processor being caused to generate a template loading page corresponding to the payment channel by using a cacheable resource on a payment page of the payment channel comprises being caused to:
determine the cacheable resource on the payment page of the payment channel based on response header information on the payment page of the payment channel, wherein the response header information comprises a cache mark corresponding to each element on the payment page.

20. The non-transitory computer-readable nonvolatile storage medium according to claim 19, wherein the response header information comprises cache control header information; and
the processor being caused to determine the cacheable resource on the payment page of the payment channel based on response header information on the payment page of the payment channel comprises being caused to:
for any element on the payment page of the payment channel, determine, based on cache control header information corresponding to the element, whether the element has a cacheable mark; and
determine, based on a determining result, whether the element is a cacheable resource.

21. The non-transitory computer-readable nonvolatile storage medium according to claim 20, wherein the cache control header information comprises expiration time information; and
the processor being caused to determine, based on a determining result, whether the element is a cacheable resource comprises being caused to:
determine an update period of the element based on the expiration time information corresponding to the element; and
determine, based on the determining result and the update period, whether the element is a cacheable resource.

22. The non-transitory computer-readable nonvolatile storage medium according to claim 18, wherein the processor before being caused to generate a template loading page corresponding to the payment channel by using a cacheable resource on a payment page of the payment channel, is further caused to:
for any payment channel, send a virtual payment order to a service provider that provides the payment channel, and obtain an interface address returned, based on the virtual payment order, by the service provider of the payment channel; and
determine a payment page of the payment channel based on the obtained interface address.
